(19) United States
(12) Patent Application Publication
(10) Pub. No.: US 2007/0247431 A1
(43) Pub. Date: Oct. 25, 2007

(54) KEYPAD AND SENSOR COMBINATION TO PROVIDE DETECTION REGION THAT OVERLAYS KEYS

(76) Inventors: Peter Skillman, San Carlos, CA (US); Eric Liu, Santa Clara, CA (US)

Correspondence Address: SHEMWELL MAHAMEDI LLP, 4880 STEVENS CREEK BOULEVARD, SUITE 201, SAN JOSE, CA, 95129, US

(21) Appl. No.: 11/379,552

(22) Filed: Apr. 20, 2006

(51) Int. Cl. G09G 5/00

(52) U.S. Cl. 345/169

(57) ABSTRACT

A computing device is provided comprising a keypad having a plurality of key structures, and a sensor mechanism. The sensor mechanism is positioned with respect to the keypad to provide a sensor detection region that overlays at least a portion of the keypad. The sensor mechanism is configured to detect an object in the sensor detection region and provide an output indicating the detected. The computing device further includes one or more processors that are programmed, instructed or otherwise configured to (i) receive an input signal that corresponds to the output of the sensor mechanism; and (ii) perform an operation in response to the input signal.

### TECHNICAL FIELD

The disclosed embodiments relate generally to input mechanisms for computing devices. In particular, embodiments described herein relate to a sensor mechanism that can be used in connection with a keypad to provide a sensor detection region that overlays the keypad.

### BACKGROUND

Computing devices typically rely on keypads as a primary source of receiving input. Over the years, much as been done to advance the usability of keyboards and other keypads in different environments. Furthermore, different types of sensor mechanisms have been incorporated with keyboard and keypad layouts. These sensor mechanisms include touchpads, which detect touch on small padded areas in the proximity of a keypad.

In the environment of mobile computing devices, size becomes an issue. Mobile computing devices include devices that utilize cellular telephony and data. These devices often seek to confine the real estate devoted to keypads to preserve a small form factor. For devices that use messaging, for example, much effort has been placed into making keypads that have keyboard functionality and other added functionality centering around user-input.

### BRIEF DESCRIPTION OF THE DRAWINGS

FIG. 1 is an exploded and simplified block diagram of a key structure assembly of a computing device having a sensor layer, under an embodiment of the invention.

FIG. 2A and FIG. 2B illustrate implementations of a keypad having an integrated sensor layer, under one or more embodiments of the invention.

FIG. 3 illustrates a computing device that is configured to provide a front face that combines keypad and field sensor functionality, according to an embodiment.

FIG. 4 is a simplified hardware diagram of a computing device that is equipped to provide an overlaying sensor detection region, under an embodiment of the invention.

FIG. 5 illustrates a capacitive pad for use with one or more embodiments.

FIG. 6 illustrates a method or process in which an overlaying sensor region can be implemented, under an embodiment of the invention.

FIG. 7 illustrates a method for distinguishing a key strike event from a sensor input, under an embodiment.

### DETAILED DESCRIPTION

Embodiments of the invention include a keypad that is combined with a sensor mechanism so as provide a sensor detection region that overlays some or all of the keys in the keypad. Under one or more embodiments, a key or button or other key structure (collectively referred to as “keys”), keyboard or other arrangement of keys are combined with a sensor mechanism that detects objects and/or movements in a detection region that overlays some or all of the keys. In one embodiment, the sensor mechanism detects an object brought into the detection region. In another embodiment, the sensor mechanism detects one or more characteristics of the object's movement in the detection region of the sensor mechanism.

A keypad, keyboard or other arrangement of keys having provided an overlaying sensor detection region, such as described herein, may be implemented on numerous types of devices. For example, one or more embodiments may be implemented on a computing device in which a small form-factor keyboard or keypad is provided. Another embodiment may be implemented as an accessory device for such a computing device. For example, one or more embodiments may be implemented on a device that can attach and detach with a computing device.

As used herein, the term “keypad” refers to any arrangement or collection of keys. A “keyboard” is a specific type of keypad, providing one primary purpose of assigning alphabet characters to individual keys.

In an embodiment, a computing device is provided comprising a keypad having a plurality of key structures, and a sensor mechanism. The sensor mechanism is positioned with respect to the keypad to provide a sensor detection region that overlays at least a portion of the keypad. The sensor mechanism is configured to detect an object in the sensor detection region and provide an output indicating the detected. The computing device further includes one or more processors that are programmed, instructed or otherwise configured to (i) receive an input signal that corresponds to the output of the sensor mechanism; and (ii) perform an operation in response to the input signal.

In another embodiment, a computing device includes an electrical contact layer having a plurality of electrical contacts, and a key structure layer comprising a plurality of key structures. Each of the key structures may be configured to travel inward to cause a switching event with an electrical contact of the electrical contact layer. The computing device further comprises a sensor mechanism that is provided at least in part between the key structure layer and the electrical contact layer. The sensor mechanism is configured to generate an output that indicates a change in a field property of the sensor mechanism. The computing device further comprises one or more processors that are programmed, instructed or otherwise configured to (i) receive an input signal that corresponds to the output of the sensor mechanism; and (ii) perform an operation in response to the input signal.

According to another embodiment, a key structure assembly includes a key structure layer, and a sensor layer. The key structure layer includes a plurality of key structures. Each of the plurality of key structures is configured to travel inward to cause a switching event with an electrical contact layer. The sensor layer is provided at least in part between the key layer and the electrical contact layer. The sensor layer is configured to generate an output that indicates a capacitive change in the sensor layer.

Still further, another embodiment provides for operating a computing device by detecting a presence of an object, where the object is either in contact with or within a designated range from, a contact surface of one or more key structures of the computing device. The detected presence of the object may be interpreted as an input, independent of inward travel of any of the one or more key structures.

The term footprint means a two-dimensional area or span. A footprint of a keypad, for example, means a two-dimensional area that spans the keypad.

As used herein, the term horizontal and vertical refer to directions that span a footprint of a keypad. In contrast, the term “Z-direction” refers to a direction relating to height above such a footprint.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Keypad with Integrated Sensor Layer

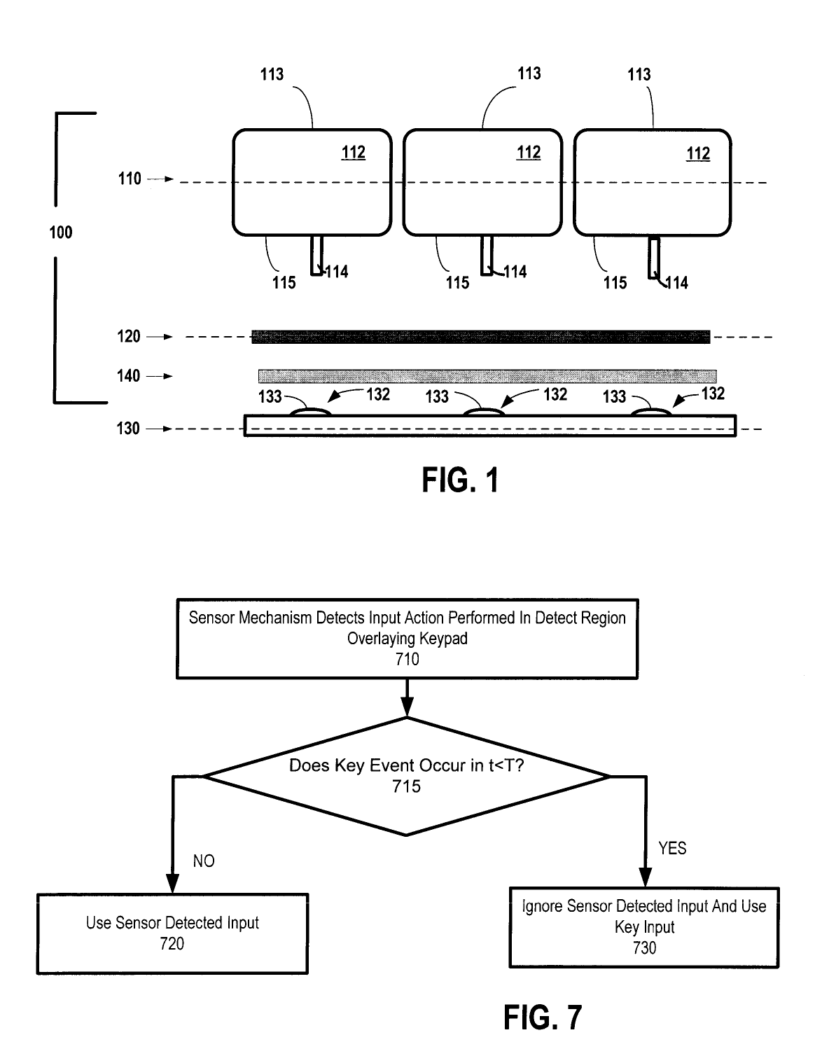

FIG. 1 is an exploded and simplified block diagram of a key structure assembly of a computing device that is integrated with a sensor mechanism, under an embodiment of the invention. An assembly 100 (sometimes referred to as a stack) includes a key structure layer 110, a sensor layer 120 and an electrical contact layer 130. The key structure layer 110 includes individual key structures 112 that are insertable. The key structures 112 are individually aligned so that insertion of each key structure results in actuation of a corresponding contact element 132 of the electrical contact layer 130. Actuation of each contact element 132 results in an electrical signal that is subsequently interpreted by a processing resource of the computing device.

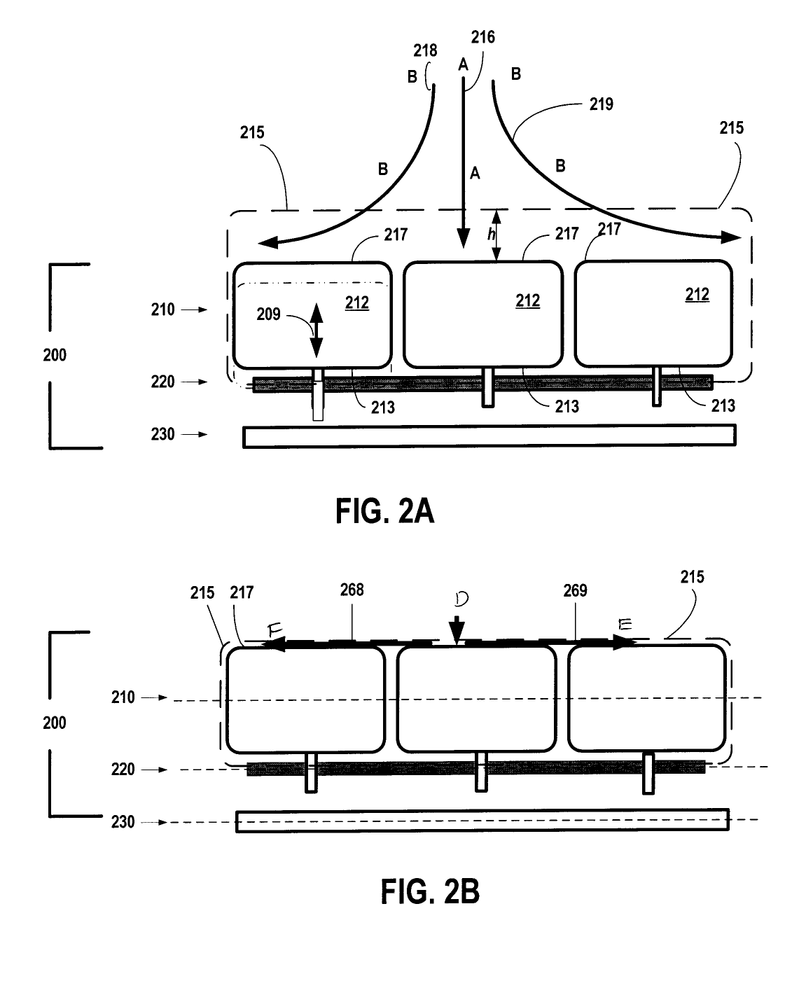

According to one or more embodiments, the sensor layer 120 provides a sensory detection region that overlays some or all of the keypad. The sensor detection region may extend in the Z-direction to and beyond contact surfaces 113 of individual key structures 112. As shown and described with other embodiments (e.g. see FIG. 2B), the sensor detection region may correspond to a field that extends a thickness above the contact surfaces 113 of the individual key structures 112. The sensor detection region may detect (i) presence of an object (such as a pen, stylus or finger) within the field of the sensory layer 120, (ii) position of the object (e.g. which key structure is overlaid with the object), (iii) movement of the object within a volume or area of the sensor's field, and/or (iv) proximity of the object to the contact surfaces 113 of the key structure 112.

According to an embodiment, certain cases of an object being present or moving in the sensor detection region provides an input that is different than actuation of the key structure. In one embodiment, for example, an object's movement results in a processor interpreting the movement as a gross input. Gross input includes inputs such as navigational inputs, scrolling actions, and other inputs that involve magnitude or degree. As a result, one or more embodiments enable presence or movement of fingers or other objects over key structures of a computing device to serve as a particular kind of input, distinct from actuation of individual key structures in the key structure layer 110.

The key structure layer 110 may provide key structures 112 in the form of buttons, keypads, keypads and other similar mechanisms. In one embodiment, a sufficient number of key structures 112 are provided with the key structure layer 110 to form a QWERTY style keyboard, or alternatively a quasi-QWERTY keyboard. In another embodiment, key structure layer 110 provides a number or dialing pad. Numerous types of keypad layouts are contemplated. For example, one implementation provides for an alphabet centric keypad (e.g. a keyboard), in which only a subset of the individual key structures 112 have potentially numerical values. Another implementation provides for a numeric centric keypad, in which the individual key structures 112 have default numerical value assignments, as well as alternative alphabetical assignments.

One or more embodiment contemplate key structures 112 that are insertable, such as through a pressing action of the user, to register in input value assigned to that particular key structure. Accordingly, individual key structures 112 may include actuation members 114 which extend inward towards electrical contact layer 130. Depression or inward movement of one of the key structures 112 results in a corresponding actuation member directing or forcing an aligned contact element 132 of the electrical contact layer 130 to switch. Under one implementation, contact elements 132 are snap-dome elements, having collapsing conductive exterior surfaces 133. Each of the exterior services 133 can be collapsed by the aligned actuation member 114 when that actuation member is directed inwards by insertion of the corresponding key structure 112. The actuation members 114 may be integral formations on a bottom side 115 of individual key structures 112. Alternatively, as shown and described by U.S. patent application Ser. No. 11/114,941 (hereby incorporated by reference in its entirety), actuation members 114 may be provided as a separate layer or matrix from the key structure layer 110.

In an embodiment such as shown by FIG. 1, sensor layer 120 is positioned in the stack or thickness of assembly 100, between the bottom sides 115 of the key structures 112 and the electrical contact layer 130. The sensor layer 120 may be in the form of a pad, or a combination of pads, that extend over a region or the entirety of the electrical contact layer 130. In one implementation, actuation members 114 press against, but not through the sensor layer 120. When corresponding key structures 112 are pressed, the actuation members 114 can direct force on to the aligned contact elements 132 (e.g. collapse an aligned snap dome), even with the sensor layer 120 forming an intermediate thickness between the actuation members and the individual contact elements. In another variation, the actuation members 114 pierce through the thickness of the sensor layer 120 and can contact the aligned actuation members directly. For example, the sensor layer 120 may be in the form of a capacitive pad that forms a matrix of a thickness that is sufficient to hold at least a portion of the overall length of individual actuation members 114.

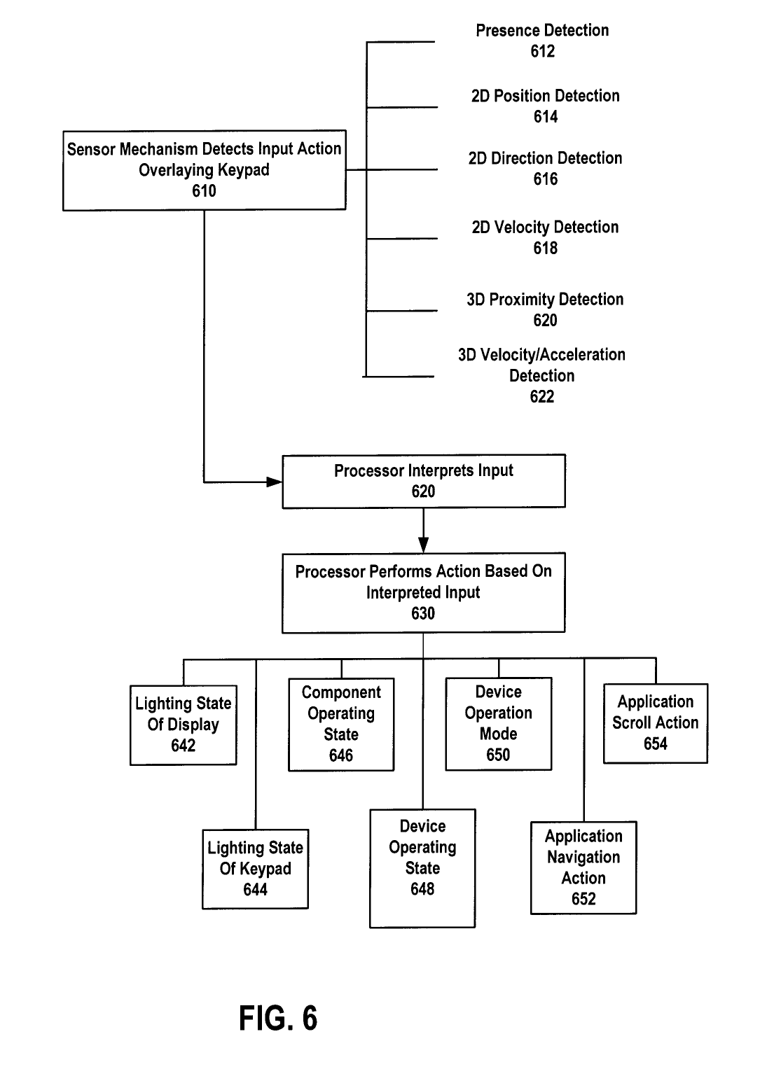

Various alternatives, features and options are possible for inclusion in the assembly 100. In FIG. 1, one variation is shown in which an illumination layer 140 is disposed underneath the key structures 112. The illumination layer 140 may comprise of, for example, a pad of Light Emitting Diodes (LEDs) and/or a layer of electroluminescent material. As described with FIG. 6, for example, one embodiment provides that input detected through the sensor layer is used to change an operational state of the illumination layer 140.

An embodiment such as shown by FIG. 1 thus enables a user to have multiple types of available interface features for entering or registering input. The various interfaces may be in a footprint provided by the overall keypad. For example, a user may and operate a keypad (e.g. compact QWERTY keyboard or dial pad), or use presence and/or movement of an object in a sensor detection region that overlays a keypad to enter other input. Numerous variations and details are described in greater detail herein.

FIG. 2A and FIG. 2B illustrate implementations in which a sensor layer is integrated into a keypad assembly, under one or more embodiments of the invention. In FIG. 2A, a stack 200 includes a key structure layer 210 on which a plurality of key structures 212 are provided. In addition, the stack 200 includes a sensor layer 220 and an electrical contact layer 230. The sensory layer 220 projects a field 215 that extends a height h over an exterior surface 217 of the key structure layer 210. The field 215 defines a sensor detection region. While the height h may vary based on design and implementation, an embodiment shown by FIG. 2A contemplates a measurement sufficient to accommodate the entire thickness of a human finger. A user can operate the key structures 212 (as described below) and/or provide other input through use of the field projected from the sensor layer 220.

As described with an embodiment of FIG. 1, a user may press or contact individual key structures 212 to operate the overall keypad in a traditional sense. In an embodiment shown, key structures 212 include individual actuation members 214, integrated to an underside 213 of the individual key structures, or alternatively formed on a matrix material separate form the key structures. In either case, one embodiment provides that key structures 212 are capable of causing inward travel of actuation members 214, through inward movement, deformation or combination thereof. Inward travel of one of the actuation members 214 as a result of a “key press event” may cause a value to be entered or action to be performed, depending on the operating designation of the particular key structure. The “key press” event is illustrated by motion arrow 209, which illustrates movement of a given one of the key structures 212 from a default state (“before key press”) to an inserted state (“after key press”).

Additionally, the user may enter input through use of the field 215, which overlays the key structure layer 210. In one embodiment, such input is independent of the operation of the keypad (i.e. the pressing of key structures). Several types of inputs are contemplated through use of the overlaying field 215, including: (i) presence of an object in the field, (ii) directional movement of the object within the field, (iii) position of the object in the field 215, (iv) velocity of the object's movement in the field, and (iv) acceleration of the object's movement in the field. For purpose of this discussion, an object may refer to a finger, a stylus or other user-directed member or element.

An object entry input 216 (as shown by line arrow A-A showing an object entering the field 215), for example, can be used to register presence input, in that once a object enters the field, a certain input may be registered with a processing resource. In one implementation, the presence input may be of a binary nature, in that one of two possible values are possible: “present” or “not present”. If the value corresponds to “present” (or the alternative “not present”), an action may be performed, such as the switching of a device or component state (backlighting, display, or operational mode). Variations are possible. For example, a keypad or keyboard formed by the key structures may have delineated or identifiable regions, and presence input in one or more or those regions may mean different things.

FIG. 2A illustrates further the use of movement inputs 218, 219. Movement inputs 218 and 219 illustrate a movement type input, corresponding to a object entering and moving within the field 215. Movement inputs 218, 219 may be interpreted through (i) direction, (ii) position, (iii) velocity, and/or (ii) acceleration. The presence of a object that is to have movement input may also be factored into the value and type of input. With regard to direction, each of movement inputs 218 and 219 may signify separate inputs, as designated for upward movement and downward movement. In one embodiment, the movement of objects in the field 215 may provide 2, 4 or 8 way directional inputs. For example, 2-way scrolling, or 4-way navigation may be made possible through use of movement inputs 218, 219.

In addition to presence and direction, one or more embodiments contemplate detection and use of other magnitudinal inputs. Magnitudinal inputs can be determined through different properties of the object's movement in the field 215. As an example, in the context of a scroll action, a magnitudinal input can determine whether the scroll action initiated by the object should be a heavy or light scroll action. Magnitudinal inputs may be provided by various properties of the movement 218, 219, including for example, the velocity or acceleration of the object moving within the field 215 (in either two-dimensions or three-dimensions), as well as the proximity of the object being moved to the contact surfaces 217 of the different key structures 212. The positioning of an object (either in two or three dimensions) in the field 215 may also be used to make an interpretation of a magnitudinal input.

In one embodiment, sensor layer 220 is an electric field sensor. An example of an electric field sensor is a pad that detects changes in a capacitive field emitted from the pad (“capacitive pad”). Thus, a capacitive pad measures changes in capacitance as a result of the presence or movement of a object in its field thickness. For example, movement of a object slightly distal to the contact surfaces of the key structures may be weakly detected and evaluated as such, while movement in light contact with the contact surfaces is strongly detected and evaluated by sensor layer 220. In one embodiment, the horizontal velocity of the movement is represented by the amount of change detected across a dimension of the footprint of the electric field as a function of time. Similarly, horizontal acceleration may be detected across the dimension of the electric field through a mapping or understanding of the velocity of the movement at different regions of the footprint of the field. In addition to horizontal velocity and acceleration, vertical velocity and/or acceleration may also be detected for purpose of determining magnitude and other characteristics of the sensory input. For example, the overall field change resulting from entrance of a object into the field 215, as measured over time, may indicate the vertical velocity or acceleration of the object as its move downwards towards the key structure layer 210.

The following provide examples of characteristics of a object's interaction with the field 215 for purpose of interpreting magnitudinal input: (i) the overall length of the object's movement within the field, (ii) the proximity of the object's movement to the center or edge or other position of the field, (iii) the velocity or acceleration of the object's movement as it spans the keypad, and (iv) the downward velocity or acceleration of the object's movement when it first enters the field 215. Numerous other variations, combinations and alternatives are contemplated

A processing resource for a computing device on which a keypad such as shown by FIG. 2A is provided can perform numerous different operations, functions or actions based on values carried through magnitudinal input. Examples of the use of such magnitudional inputs include scrolling or navigational movement, electronic cursor/pointer positioning; and hardware device control (e.g. volume for a speaker, contrast for a display).

FIG. 2B illustrates the stack 200 with the sensor layer 220 configured to provide a sensor field for detecting user-initiated grazing of key structures 212, under an embodiment. In contrast to FIG. 2A, an embodiment such as shown by FIG. 2B provides that the height h that defines the thickness of the field 255 over exterior surfaces 217 of the key structure layer 210 is relatively small (e.g. almost zero). As such, use of the sensor layer 220 requires that the user bring the object into contact with the exterior surfaces 217 of the individual key structures 212. While the user may direct contact between the object and the individual key structures 212, such contact is not sufficient to cause inward travel of the key structures 212, at least to an extent of causing a key press event.

Thus, while an embodiment such as described with FIG. 2A contemplates the potential for three-dimensional input with use of the object, an embodiment such as described with FIG. 2B contemplates two dimensional object input. Furthermore, an embodiment such as shown by FIG. 2B provides the user with an inherent mechanical stop in the form of the key structure layer. Such a mechanical stop ensures the user has tactile feedback as to when object input is registered. Furthermore, a user is better able to use one or multiple fingers to graze the key structure layer and enter input through use of the sensor field 215. The user can also switch between using key presses and grazing (for sensory input) when operating the computing device with fingers on the keypad.

As with FIG. 2A, an embodiment such as shown by FIG. 2B can provide the sensor field 215 to overlay the keypad of a computing device in order enable a user to enter one or more of presence input, directional input and magnitudinal input. Presence input 266 is illustrated by arrow D. Movement input 268, 269 (Arrows E and F) may provide directional and/or magnitudinal input, as described with an embodiment of FIG. 2A.

Implementation Example

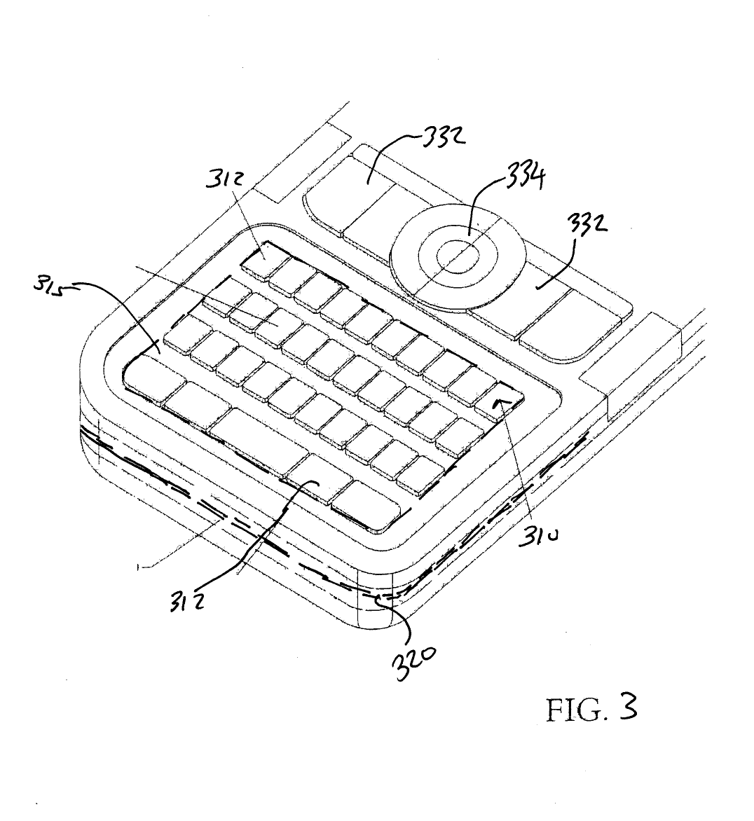

FIG. 3 illustrates a computing device that is configured to provide a front face that combines keypad and field sensor functionality, according to an embodiment. A computing device 300 may correspond to a device on which telephony and messaging applications are operated. Such devices are sometimes referred to as “smart phones” or “hybrid devices”. As such, a keypad 310 of the computing device 300 includes alphabetical and numerical input assignments and modes. In an embodiment such as shown, keypad 310 includes an array of key structures 312, sufficient in number so that each alphabet character is assigned one key structure. The layout of the array may be in the form of a QWERTY keyboard.

While an embodiment of FIG. 3 illustrates a computing device, other embodiments contemplate use of any device that incorporates keys, such as, for example, laptop computers, traditional cellular phones, personal digital assistants (PDAs), gaming machines, portable music players (audio and video), digital cameras and small form-factor multi-functional and thick computing devices.

The keypad 310 includes a footprint 315 that defines a particular span. One or more field sensor mechanisms 320 may form a sensor layer or thickness that underlies the keypad 310. As described with FIG. 2A and FIG. 2B, the field or view of the sensor mechanism 320 may extend over just a portion of the footprint 315 of keypad 310, or extend the entirety of the footprint, or still further, extend beyond one or more boundaries of the footprint 310.

As described elsewhere, the type of user interaction that can register input with the sensor mechanism 320 is one of design and implementation. In one embodiment, individual key structures 312 of the keypad 310 can be grazed (i.e. contacted without insertion) so that at least a portion of the footprint 315 of the keypad 310 (or individual keys 312) serves the dual purpose of providing insertable keys and a touchpad or other sensor interface functionality (see FIG. 6).

While an embodiment of FIG. 3 illustrates the detection region of sensor mechanism 320 overlaying the keypad 310, other embodiments contemplate providing the detection region on other areas of the computing device, and in particular, over key structures or buttons that are outside of the keypad arrangement. In FIG. 3, computing device 300 includes key structures or application buttons 332 and navigational buttons 334. In one embodiment, one or more of the application buttons 332 and navigation buttons 334 is combined with a sensor mechanism that detects object presence and/or movement in an area just above those buttons. The sensor mechanism 320 for the application and/or navigation buttons may be in addition to or as an alternative to another sensor mechanism or layer underneath the keypad 310.

Hardware Diagram

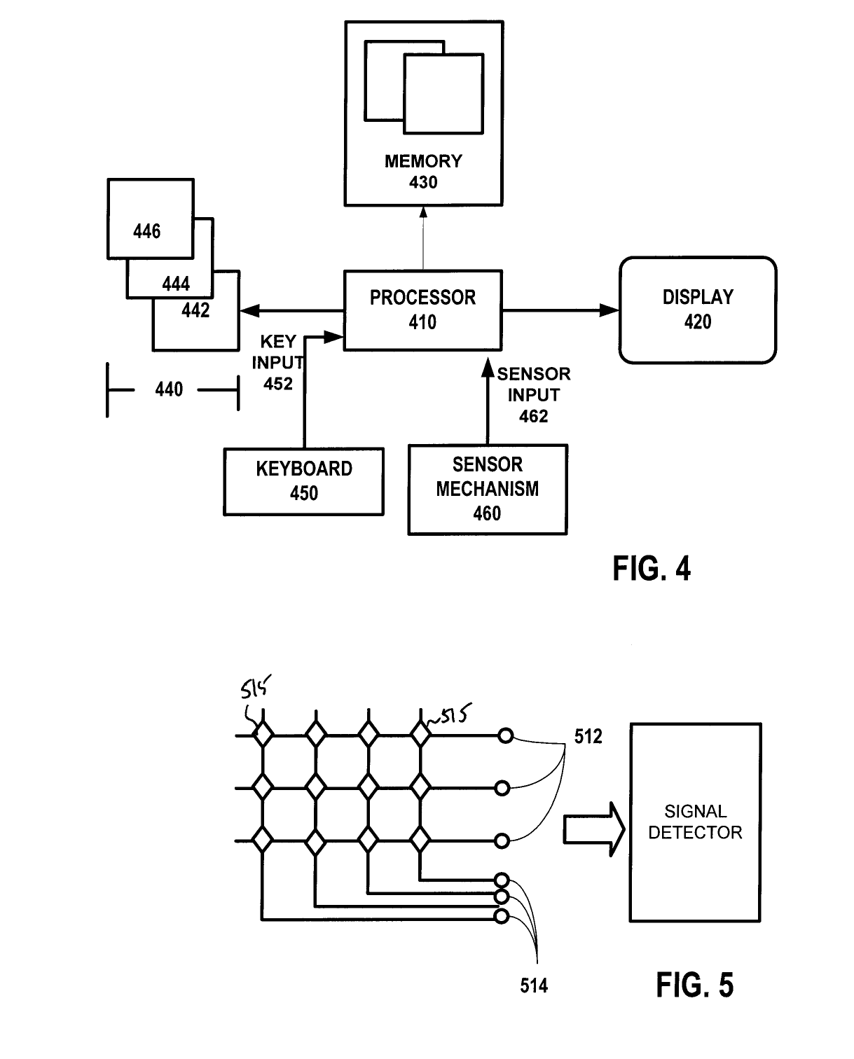

FIG. 4 is a simplified hardware diagram of a computing device that is equipped to provide an overlaying sensor detection region, under an embodiment of the invention. A computing device includes a processor 410 (or processing resource, such as multiple processors), a display 420, one or more memory resources 430, components 440, a keypad 450 and a sensor mechanism 460. The memory resources 430 may include different kinds of memory, including volatile or non-volatile memory. The display 420 may also be contact-sensitive, so as to receive input with touch. The keypad 450 may have anyone of numerous configurations or designs, depending on, for example, the functionality of the computing device (e.g. cellular phone versus hybrid device). The sensor mechanism 460 may detect objects that are present or move within a detection region, that overlays some or all of the keypad.

The keypad 450 may include one of many different layouts. For example, keypad 450 can be either alphabetic centric or numeric centric. An alphabet centric layout includes keys that are assigned both alphabet and numeric values, but the layout, including the number of keys provided, favors use of the keys as a keyboard. A numeric centric layout favors numeric uses (e.g. dial pad), so fewer key may be provided. For example, predictive text software may be combined with use of the keypad to enable alphabet entry in a particular mode. A key event, corresponding to a key press or other key actuation, may communicate a key input 452 to the processor 410.

In an embodiment such as shown above, the sensor mechanism 460 is an electric field sensor. In particular, the sensor mechanism 460 may correspond to a capacitive sensor pad that detects changes in capacitance brought on by the introduction of an object (such as a finger or stylus) into the sensor detection region. The sensor mechanism 460 may communicate sensor input 462 to the processor 410, corresponding to an object being brought in and/or moved within the sensor region.

In an embodiment, the processor 410 is configured to resolve when to process the sensor input 462, as opposed to the key input 452. Such configurations may be necessary because any key press event may generate both key input 452 and sensor input 462, even if the user only meant to enter the key input. In one embodiment, both types of input are possible, but if a key event occurs within a designated time interval (e.g. half a second), the key input 452 for that key event would override the sensor input 462 generated as a result of the user bringing his finger into contact with the key. However, numerous alternatives to such an implementation exist. For example, the processor 410 may be configured to only recognize and interpret sensor input 462 that is the result of the object moving over several keys. Still further, the processor 410 may recognize the sensor input 462 when the device is in a particular mode that causes the sensor mechanism to be active or operational. For example, the user may switch the device to a mode state to use the sensor mechanism 460 for purpose entering gross input, such as scrolling.

As described with other embodiments, the processor 410 may be responsive to perform actions in response to receiving sensor input 462. The sensor input 462 may carry value, indicating one or more of (i) presence, or (ii) position of object, and/or (iii) information about the object's movement. The response of processor 410 may be based in whole or in part on receiving the sensor input 462 and/or on the value of the sensor input. Depending on design or implementation, the processor 410 may perform operations that include any one or more of the following:

State change of the computing device: The operational level or state of the device may be changed in response to receiving sensor input 462. For example, the device may be switched to an operational mode from a sleep mode. Alternatively, an overall operational mode of the device may be changed.

State change of components 440: The components 440 may include, for example, backlighting for keypad 450, backlighting for display 420, speakers 442, microphone 444, wireless radio 446 or port (e.g. cellular, WiFi or Bluetooth radio), and modules incorporated in the device (e.g. global positioning system units (GPS)). In response to receiving the sensory input 462, the processor 410 may change the state of such components 430, by for example, switching power states of such components, or their operational levels.

As described with other embodiments, numerous other actions may be performed by the processor 410 in response to receiving the sensor input 462.

Under an embodiment, sensor mechanism 460 may correspond to a capacitive pad or other electric field sensor. FIG. 5 illustrates an embodiment of a capacitive pad 510 for use with one or more embodiments. The capacitive pad 510 may, for example, form the sensor layer shown in FIG. 1 and FIG. 2 and elsewhere. In general, the capacitive pad 510 works by providing an element that produces capacitive change in response to presence of charged particles. When the element is sensitive enough, it can detect charged particles in the form of static charge for example, and the object carrying it need not be conductive or in contact. Thus, for example, a finger can hover over pad to measurably affect a load.

Under an embodiment, the capacitive pad 510 includes a plurality of signal lines provided in a grid. The grid may lay flat in a thickness that underlies some or all of the footprint of the keypad. The signal lines may include horizontal lines 512 and vertical lines 514. The signal lines 512, 514 may be coupled or integrated with capacitive elements. For example, vertical and horizontal signal lines may intersect or overlay at nodes 515, and each node 515 may correspond to a capacitive element. A signal detector 520 may also tie to each line.

In one embodiment, when an object enters the detection region of the capacitive pad, it introduces charged elements that interact with one or more capacitive elements 515 to change the load on the signal lines 512, 514. For example, the introduction of the capacitive elements 515 may alter an existing load on one or more of the signal lines 512, 514, or generate a load on one of those signal lines. The following illustrate simple implementations for use of a capacitive pad 510.

Presence and/or detection of an object in a detection region: In an embodiment, nodes 515 operate as switches when sufficient capacitive change is provided by the introduction of an object. The nodes 515 may span an area of the footprint for the keypad. When an object is brought into proximity of a given node, the node may switch. Such an implementation provides (i) information that the object is present, and (ii) relative position of the object.

Horizontal Movement: With the implementation provided, horizontal direction (e.g. direction parallel to the grid formed by the sensor lines) is determined through analysis of what switches close over a given time period. As such, direction, speed and acceleration of such movement may be determined.

In either of the examples provided above, rather than configure nodes to signal on switch events, an alternative implementation may simply measure change in capacitance on the individual signal lines 512, 514, with no switching. The signal detector 520 may detect changes in the load of individual signal lines, where such changes are brought by the introduction of the object to the sensor detection region. For example, the signal lines 512, 514 may provide or couple to capacitive elements that provide voltage differential when an object is in the sensor region. The vertical line with the greatest voltage may, for example, locate the vertical coordinate of the object over the grid, while the horizontal line with the greatest voltage may provide the horizontal coordinate. As the coordinates change in time, information about the object's movement, including direction, velocity and/or acceleration may be determined.

Z-movement detection: Z-movement refers to movement that is into our away from the grid. As such, the Z-axis may correspond to a perpendicular axis. In one embodiment, the processing resource of the computing device detects the Z-height of the object, and interprets input based on this information. To provide an example, a lateral movement of an object at a Z-distance that is relatively distal may have a particular interpretation, such as a weak scroll action, while the same action performed more proximate to the grid may be interpreted as a strong scroll action (thus a heavier scroll).

Still further, the processing resource may detect change in the Z-height, such that is interpret additional information based on the change of the object's position with respect to the grid. For example, a user may bring his finger suddenly into contact with a surface of a key to signal one input, while the same act done more slowly may connote a different input.

Methodology

FIG. 6 illustrates a method or process in which an overlaying sensor region can be implemented, under an embodiment of the invention. A method such as described in FIG. 6 may be implemented on, for example, a computing device, through use of hardware such as described with FIG. 4 and FIG. 5.

In step 610, a sensor mechanism detects an input action that overlays a keypad of the computing device. According to one or more embodiments, the input action may correspond to one or more of the following be detected: (i) presence detection 612, (ii) two-dimensional position detection 614, (iii) two-dimensional direction detection 616, (iv) two-dimensional velocity/acceleration detection 618, (v) three-dimensional proximity detection 620, and/or (vi) three-dimensional velocity/acceleration detection 622. Presence detection 612 corresponds to, for example, a binary determination that an object is brought into the detection region of a sensor that underlies or is otherwise integrated into the keypad of the computing device, regardless of the movement or position of the object. Two-dimensional position detection 614 may correspond to determining a relative position of the object in a span that overlays the keypad. For example, Cartesian coordinates may be used to determine the position of the object. Two-dimensional direction detection 616 may correspond to a detection of the object along, for example, a vertical or horizontal axis of the footprint of the keypad. The two-dimensional velocity/acceleration detection 618 may correspond to detection of values indicating velocity or acceleration of the object in a span that overlays the keypad. The three-dimensional proximity detection 620 corresponds to a detection of whether the object is proximate or distal to the contact surface of the keys. For example, the object may correspond to a finger that grazes the keys of the keypad, or to a finger that hovers over, but not in contact, with those keys. Likewise, the three-dimensional velocity/acceleration detection 622 may represent a value describing the motion of the object as it moves towards the keypad from a given Z-distance. For example, the user may finger a surface of the keypad with speed or velocity, and this may be distinguishable from a use who floats the finger slowly towards the keypad.

As mentioned, design and implementation may determine which of the input actions are detectable by a given embodiment. Thus, one embodiment may simply detect object presence, while another embodiment may detect its two-dimensional position. As shown by FIG. 2A and FIG. 2B, the extend by which the detection region of the sensor mechanism is projected over the keypad in the Z-direction may also be one of design implementation, so that, for example, only actions that graze the keypad are detectable. Such an implementation would eliminate the three-dimensional detection.

Under an embodiment, a step 630 provides that a processor interprets the input action. The processor may determine one or more values that are provided by the input action. The value may be BOOLEAN, for example, such as when the processor detects presence only. As another example, the value may correlate to a direction or position, or the value may be magnitudinal in that it connotes a specific value in a given range of possible values.

In step 630, a processor performs an action based on the interpretation of the input action from step 620. In addition to numerous types of detections being contemplated, embodiments further contemplate numerous possible actions that can be performed in response to detecting a particular input action, or value for a given input action. Sub-steps 642-656 illustrate examples of actions that can be performed, according to one or more embodiments.

Subs-step 642 provides for altering the lighting state of a display in response to the input action. This may correspond to, for example, turning the backlight on or off, or making the screen of the device brighter. For example, the device may have one or more lighting components switch on in response to an object grazing the keypad. This enables the device to conserve power, and for the user to perform a simple action of placing a finger on the keypad.

In a sub-step 644, the lighting state of a keypad may be altered. For example, some keypads have backlighting options to illuminate when conditions are dark, or when in use. By turning the backlight of the keypad on only when, for example, an object is detected as being present (e.g. finger grazes a keypad), an embodiment enables conservation of device power.

A sub-step 646 provides for altering or changing the operational state or mode of other components of the device. For example, detection and interpretation of the input action may result in one or more wireless radios being turned on or off (Wireless Fidelity Radio, Bluetooth Radio, cellular radio). As another example, the speakers of the device may be switched from one state to another (mono to stereo). Likewise, the microphone may be switched on or changed in setting by being powered or changed in setting to provide conferencing functionality.

The sub-steps 640-646 illustrate embodiments in which object presence detection 612 may be used to perform a simple binary operation, such as turn a lighting component on or off. Such an operation may be performed in response to presence detection 612, or through values interpreted from other input actions. For example, a value representing one directional motion may trigger backlight of the keypad, while the opposite direction triggers another action. However, any of the actions described with sub-steps 640-644 may be performed with magnitude that is determined from properties of movement or positioning of the object in the sensor detection region. For example, a high-magnitude event (e.g. object moved fast and/or close to keypad) may cause a backlight to have full power, while a low-magnitude event (e.g. slow object movement and/or far from keypad) may cause a backlight to be dimmed or have dim power.

In another embodiment, a sub-step 648 corresponds to an alteration of a device operating state. For example, the device may be turned on from a sleep-mode or off state with, for example, presence detection 612. Alternatively, the device may be operated under a given power consumption profile based on a value interpreted from the input action.

Aside from power, the operational mode of the device may also be set through the input action in a sub-step 650. For example, the device may have its cellular telephony capabilities switched on or off, or be provided a roaming or local profile based on an interpreted value of the input action. In another embodiment, the device may be a multi-functional hybrid device, such as an audio player, cellular telephony device, messaging device, and/or Global Positioning Device. The specific mode of operation selected may be based on the value of the input action detected.

One or more embodiments contemplate other actions that the processor may perform in response to receiving the input action. Among them, the processor may perform a navigation operation in sub-step 652, in which an object is selected through directional or spatial input for example. The processor may alternatively perform a scrolling operation in sub-step 654, in which case a document or other electronic item is scanned, presumably in one direction or another. Under one implementation, for example, each of these actions may require use of magnitudinal input (e.g. as determined from proximity or velocity value) as well as directional value.

As described above, the particular action performed may be based on one or more, or a combination thereof, of presence, direction, position, and magnitude. Thus the exact operations that can be performed through the interpretation of an input action are too numerous to list. As described, an embodiment provides for a processor to interpret the input action, and to configure or control or operate another component, set of components, and/or software or other programming.

Since embodiments described herein contemplate overlaying a sensor detection region on a keypad, an input resolution protocol may be needed to distinguish when (i) sensor input is to be ignored over key strike events, (ii) sensor input is to supplement key strike events, or (iii) sensor input is to overrule key strike events. In one embodiment, the role of the sensor mechanism may be set by a mode setting, such as through a hardware or software switch. In another embodiment, any sensor input that precedes a key strike event is ignored. Thus, when the user contacts the keys to press one down, the sensor mechanism input may be ignored.

FIG. 7 illustrates a method for distinguishing a key strike event from a sensor input, under an embodiment. In step 710, an input action (such as described with FIG. 6) is detected. In one implementation, timing with relation to a key strike event is used to determine whether the sensor mechanism input is to be used or not. Thus, in step 715, a determination is made as to whether a key event occurs within a given time duration (e.g. less than half a second) following an input action detected through use of the sensor mechanism. If no key event occurs within the duration, the sensor mechanism input action is used in step 720, meaning the input value is interpreted and acted on. If the key event follows within the duration, then step 730 provides that the sensor detected input action is ignored. In one embodiment, any key activity causes all sensor input to be ignored for a duration, so as to enable a user to operate the device without having to worry about touching the keypad inadvertently.

### Alternative Embodiments

While embodiments described herein contemplate a sensor mechanism that underlies keys of a keypad, one or more embodiments consider placement of the actual sensor mechanism in a position that does not underlie the keys. For example, a sensor mechanism may exist over the keypad, such as to form a periphery of the footprint of the keypad.

Furthermore, while one or more embodiments describe a sensor layer or mechanism that underlies the keys of the keypad and projects the sensor detection region over the keypad, other embodiments contemplate a similarly positioned sensor layer or mechanism that projects the sensor detection region outside of the keypad's footprint.

In addition, while one or more embodiments describe use of capacitive pads and sensors, other types of field sensors are contemplated, such as those that use magnetic properties (e.g. to detect metal objects), radio-frequency signals, or inductive properties.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A computing device comprising:
a keypad having a plurality of key structures;
a sensor mechanism that is positioned with respect to the keypad to provide a sensor detection region that overlays at least a portion of the keypad, wherein the sensor mechanism is configured to detect an object in the sensor detection region and provide an output indicating the detected object; and
one or more processors configured to:
receive an input signal that corresponds to the output of the sensor mechanism; and
perform an operation in response to the input signal.

2. The computing device of claim 1, wherein the sensor mechanism underlies at least a portion of the keypad.

3. The computing device of claim 2, wherein the computing device comprises:
an electrical contact layer comprising a plurality of electrical contacts; and
wherein individual key structures of the keypad are aligned with a corresponding electrical contact in the electrical contact layer, and wherein the individual key structures are configured to travel inward to actuate the corresponding electrical contact layer; and
wherein the sensor mechanism is provided as a layer between the keypad and the electrical contact layer.

4. The computing device of claim 3, wherein individual key structures of the key pad are provided actuation members that pierce through the layer of the sensor mechanism in order to actuate the corresponding electrical contact.

5. The computing device of claim 4, wherein individual key structures of the key pad are provided actuation members that push against the layer of the sensor mechanism in order to actuate the corresponding electrical contact.

6. The computing device of claim 1, wherein the sensor mechanism is a capacitive field sensor.

7. The computing device of claim 1, wherein the processor interprets the output of the sensor mechanism to correspond to at least one of (i) a presence of an object in the sensor detection region, (ii) a position of the object in the sensor detection region, (iii) a direction of movement of the object in the sensor detection region, (iv) a velocity of acceleration of the movement of the object in the sensor detection region, or (v) a proximity of the object to individual key structures in the keypad.

8. The computing device of claim 1, wherein the sensor detection region overlays at least a portion of the keypad so that the sensor mechanism detects an object in the sensor detection region only when the object contacts one or more key structures in the keypad.

9. The computing device of claim 1, wherein the operation performed by the one or more processors include one or more operations selected from a group of operations consisting of: (i) an operation for altering a lighting state of one or more components of the computing device, (ii) an operation for altering an operating state of the computing device, (iii) an operation for altering the operating state of one or more components of the computing device, (iv) an operation for altering a mode of operation of the computing device or one or more components of the computing device, (v) a scrolling operation, or (vi) a navigation operation.

10. The computing device of claim 9, wherein the one or more components include a component selected from a group consisting of (i) a battery module, (ii) a display, (iii) a wireless radio, (iv) a speaker, and (v) a microphone.

11. A computing device comprising:
an electrical contact layer comprising a plurality of electrical contacts;
a key structure layer comprising a plurality of key structures, wherein each of the plurality of key structures is configured to travel inward to cause a switching event with an electrical contact of the electrical contact layer; and
a sensor mechanism provided at least in part between the key structure layer and the electrical contact layer, wherein the sensor mechanism is configured to generate an output that indicates a change in a field property of the sensor mechanism; and
one or more processors configured to:
receive an input signal that corresponds to the output of the sensor mechanism; and
perform an operation in response to the input signal

12. The computing device of claim 11, wherein the sensor mechanism is configured to produce the change in the field property in response to an object's presence a distance away from a contact surface of one or more of the plurality of key structures.

13. The computing device of claim 11, wherein the processor is configured to change a state of one or more components of the computing device in response to the input signal.

14. The computing device of claim 13, wherein the processor is configured to change one or more of a (i) a lighting state of a backlight of the key layer, (ii) a power state of a display of the computing device, (iii) a display state of the display of the computing device, (iv) an operational mode of a user-interface feature, and (v) a wake state of the computing device.

15. The computing device of claim 11, wherein the sensor mechanism is configured to generate the output when an object makes contact with the contact surface of one or more of the plurality of key structures, wherein the object making contact does not cause inward travel sufficient to cause the switching event.

16. The computing device of claim 11, wherein the sensor mechanism is capable of producing a capacitive change in response to an object being brought into a range of the pad.

17. The computing device of claim 16, wherein the sensor mechanism is capable of producing the capacitive change in response to the object being moved within the range of the pad.

18. The computing device of claim 16, wherein the sensor mechanism is configured to generate the output that is indicate of a proximity of the object to the contact surface of the one

19. The computing device of claim 11, further comprising a display, and wherein the processor is configured to perform the operation that affects what is displayed on the display.

20. The computing device of claim 11, further comprising a plurality of input/output components, and wherein the operation performed by the processor affects an operation status of one or more of the plurality of input/output components.

21. The computing device of claim 11, wherein the sensor mechanism is configured to generate the output to indicate a lateral direction of a movement of an object within a range of the sensor mechanism, and wherein the processor performs the operation based in part on the lateral direction.

22. The computing device of claim 21, wherein the operation performed by the processor corresponds to one or more of (i) a scrolling operation, (ii) a navigation operation, or (iii) a selection operation.

23. The computing device of claim 21, wherein the sensor mechanism is configured to generate the output to indicate a speed of the lateral movement.

24. The computing device of claim 11, wherein the sensor mechanism is configured to process the input signal as a gross input.

25. A key structure assembly comprising:
a key structure layer comprising a plurality of key structures, wherein each of the plurality of key structures is configured to travel inward to cause a switching event with an electrical contact layer; and
a sensor layer provided at least in part between the key layer and the electrical contact layer; and
wherein the sensor layer is configured to generate an output that indicates a capacitive change in the sensor layer.

26. The key structure of assembly of claim 25, wherein the sensor layer is configured to produce the capacitive change in response to an object's presence a distance away from a contact surface of one or more of the plurality of key structures.

27. The key structure assembly of claim 25, wherein the sensor layer is configured to generate the output in response to contact of the object with the contact surface of one or more of the plurality of key structures, wherein the contact does not cause inward travel sufficient to cause the switching event.

28. The key structure assembly of claim 25, wherein the capacitive later is configured to generate the output to indicate a proximity of the object to the contact surface of the one or more key structures.

29. The key structure assembly of claim 25, wherein the sensor layer is configured to produce the capacitive change in response to the object having a lateral movement that spans an area that overlays multiple key structures.

30. The key structure assembly of claim 29, wherein the sensor layer is configured to generate the output to indicate a direction of the lateral movement.

31. The key structure assembly of claim 29, wherein the sensor layer is configured to generate the output to indicate a speed of the lateral movement.

32. The key structure assembly of claim 25, further comprising an actuation member layer, wherein the actuation member layer includes an actuation member for each key structure in the plurality of key structures, and wherein each actuation member (i) extends from a bottom region of a corresponding key structure in the plurality of key structures and (ii) is aligned with an electrical contact of the electrical contact layer, wherein the inward travel of the corresponding key structure causes the switching event.

33. The key structure assembly of claim 32, wherein at least some of the actuation members of the actuation member layer are merged or joined with the bottom region of the corresponding key structure.

34. The key structure assembly of claim 322, wherein at least some of the actuation members of the actuation member layer extend through the sensor layer to make connect with the electrical contact of the electrical contact layer.

35. The key structure assembly of claim 32, wherein at least some of the actuation members of the actuation member layer extend against, but not through the sensor layer.

36. The key structure assembly of claim 35, wherein the sensor layer is provided on a matrix, and wherein the matrix is deflectable, by one or more individual actuation members in the actuation member layer, into the electrical contact aligned with that individual actuation member.

37. A method for operating a computing device, the method comprising:
detecting a presence of an object, either in contact with or within a designated range from, a contact surface of one or more key structures of the computing device;
processing the detected presence as an input, independent of inward travel of any of the one or more key structures.

38. The method of claim 37, wherein detecting a presence includes detecting one or more of (i) a position of the object, (ii) a movement of the object, or (iii) a proximity of the object, to the contact surface of the one or more key structures.

39. The method of claim 37, further comprising performing a navigation operation in response to processing the input.

40. The method of claim 37, further comprising performing a scrolling operation in response to processing input.

41. The method of claim 37, further comprising changing a state of one or more components of the computing device in response to processing the input.

42. The method of claim 40, wherein the one or more components include (i) a display component, (ii) a backlight for the one or more key structures, (iii) a wireless communication component, or (iv) an audio component.

43. The method of claim 37, further comprising changing a mode of the computing device in response to processing the input.
